(19) United States
(12) Patent Application Publication
(10) Pub. No.: US 2014/0279545 A1
(43) Pub. Date: Sep. 18, 2014

(54) SYSTEMS AND METHODS FOR CREDIT CARD PROTECTION

(71) Applicants: David Enns, Herriman, UT (US); William Enns, Fresno, CA (US); Christopher A Cochran, Columbia, MD (US)

(72) Inventors: David Enns, Herriman, UT (US); William Enns, Fresno, CA (US); Christopher A Cochran, Columbia, MD (US)

(21) Appl. No.: 14/273,452

(22) Filed: May 8, 2014

Related U.S. Application Data
(62) Division of application No. 13/830,359, filed on Mar. 14, 2013.

(51) Int. Cl. G06Q 20/40

(52) U.S. Cl. CPC G06Q 20/401
USPC 705/44

(57) ABSTRACT

Systems, computer programs and methods are provided to protect consumer credit card data and/or other private information by tying such information to a particular hardware identification number, such as without limitation an individual Media Access Control (MAC) Address of a user's computer and/or mobile device. Credit card or other data is registered and associated with a hardware identification number for computer(s) or mobile device(s) of the registrant. Then, when a transaction involving the credit card occurs, the hardware identification number for the device initiating the transaction is compared with the registered hardware identification number for the credit card. If the numbers do not match, the transaction is not allowed to complete, preventing those without the hardware identification from using the registered credit card, debit card, or other registered item.

This application is a divisional of U.S. patent application Ser. No. 13/830,359, filed Mar. 14, 2013, which is incorporated herein by this reference in its entirety.

### BACKGROUND OF THE INVENTION

1. Field of Invention

The present invention relates to security of consumer credit cards when used for on-line purchases, and more particularly to systems, computer programs and methods for protecting consumer credit card information by tying such information to a hardware identification number such as an individual user's Media Access Control (MAC) Address of their computer or mobile device.

2. Description of the Related Art

Credit card theft, identity theft, fraud, and unauthorized use of credit card data and other personal information are among many challenges faced by consumers making on-line and point-of-sale (POS) purchases. A typical purchase transaction requires the consumer to provide a debit or credit card number, expiration date and/or other personal information to confirm the transaction. This information may be wrongfully obtained by unauthorized users in any of a number of ways, including being intercepted if the transaction takes place on line, copied and stored by the merchant and used by unauthorized personnel, or retrieved from illegal hacking of a merchant's customer data base. As more and more transactions take place through computers and mobile devices, the opportunities for unauthorized access continue to multiply. Once a consumer's credit card data or other private, personal information has been wrongfully obtained, unauthorized users may use that information to steal the identity of the consumer, make large unauthorized purchases, or participate in other fraudulent transactions to the detriment of the user. Existing data security systems can be easily bypassed, leaving consumers in constant danger that their credit card data and other personal information may be stolen and used without their knowledge or consent.

There continues to be a need, therefore, for an improved security system to protect consumer credit card data and other personal information from unauthorized use.

### SUMMARY OF THE INVENTION

The systems, computer programs and methods of the present invention have been designed to provide protection and security for consumer credit card data and/or other private information by tying such information to a particular hardware identification number, such as without limitation an individual Media Access Control (MAC) Address of the consumer's computer(s) and/or mobile device(s). Without this particular piece of information, even if an unauthorized user obtains the consumer's credit card data or other similar information, it cannot be used. Thus, a hardware identification such as a MAC Address acts as a verification protocol that is required before the credit card data or other information may be used, preventing those without the hardware identification from using the consumer's credit card data or other information.

In embodiments of the present invention, end users may associate their credit card or debit card numbers to authorized hardware identifications, such as the MAC address(es) assigned to their individual devices. The end user may register or subscribe credit card(s), debit card(s) or other information so that hardware identification is required for the registered or subscribed item(s) to be used. Once registered, an additional security check will automatically occur each time a registered item(s) are used, in order to ensure timely transactions and prevent fraudulent use of the information from non-authorized users or devices. In some embodiments, an additional security code may be provided that allows a single use of a credit card or other item from a non-registered device without adding the device to the authorized list.

In embodiments of the invention, security screens are performed on a secure server that contains a database of registered/subscribed credit card numbers, debit card numbers or other similar private data. Each of these subscribed items is associated with a hardware identification number, such as a MAC Address, assigned to the item as ‘authorized’. These hardware identification number(s) may be provided from any electronic device with a MAC Address or the like. When an end user attempts to make a purchase using a subscribed credit card, the credit card number is automatically sent to the secure server for verification. If the number is not in the registered database (i.e., credit card not subscribed), the user is afforded no additional security and the transaction will proceed. However, if the number is present (credit card subscribed), the hardware identification number (e.g., MAC Address) of the initiating device will be compared to the list of authorized hardware identification numbers for the subscribed item. If the hardware identification number is on the authorized list, the transaction will proceed. If the hardware identification number is not on the list, then the transaction may be prevented, or an additional security step may be required. If the additional security step is set up, the server will return a request for a security code that the end user can provide to allow single use of the unlisted hardware device. If the code provided is correct, the transaction will proceed; if not, the transaction will be cancelled.

Embodiments of the invention are also provided for point of sale (POS) transactions. In some of these embodiments, incorporating security at POS requires that all transactions receive an additional security step and security code.

In embodiments of the invention, the database containing the subject information is web accessible on a secured network via user name and password, allowing users to log in, and then manage their credit card or other accounts, performing such tasks as adding or updating credit card numbers, adding or updating hardware identification numbers, and the like.

In one aspect of the present invention, systems are provided for validating a purchase transaction transferring electronic funds from one of a plurality of issuing bank accounts to an acquiring bank account, each of the issuing bank accounts having a unique account identification number, where the systems comprise: (a) a merchant computer connected to a computer network, the merchant computer having software comprising a website enabling a consumer to make a purchase; (b) a plurality of consumer electronic devices connected to the computer network, each of the electronic device having one of a plurality of unique hardware identification numbers and having software which transmits the hardware identification number of the electronic device to the merchant computer; and (c) a verification computer connected to the computer network, the verification computer having software comprising a database with a plurality of tables, each of the tables having an entry containing one of the plurality of hardware identification numbers and an entry having one of the plurality of account identification numbers, the verification computer further having software which receives from the merchant computer a first of the plurality of hardware identification numbers and a first of the plurality of account identification numbers, and sends to the merchant computer data which identifies whether at least one of the tables includes the first hardware identification number and the first account identification number.

In another aspect of the present invention, methods for validating a purchase transaction are provided comprising such steps as: (a) using an electronic device to institute a purchase transaction transferring funds from an issuing bank account to an acquiring bank account, the electronic device having a unique hardware identification number associated therewith, and the issuing account having a unique account identification number; (b) electronically transmitting the hardware identification number to the merchant computer; (c) electronically transmitting the hardware identification number and the account identification number from a merchant computer to a verification computer, the verification computer having a database with a plurality of tables in a memory associated therewith; (d) setting a first verification data to one of the group consisting of (i) a first state if at least one table entry in the database comprises each hardware identification number and the account identification number, (ii) a second state if at least one table entry in the database comprises the hardware identification number and not the account identification number, and (iii) a third state if at least one table entry in the database comprises the account identification number and not the hardware identification number; and (e) electronically transmitting the first verification data from the verification computer to the merchant computer.

In another aspect of the present invention, processes for validating a credit card transaction are provided comprising such steps as: (a) establishing a user account with a validation service provider comprising providing the validation service provider with an approved credit card account number and an approved hardware identification number; (b) from at least one electronic device having a challenge hardware identification number, accessing a website of a merchant and instituting a purchase transaction by providing a challenge credit card account number and transmitting the challenge hardware identification number; (c) requesting the validation service provider to validate the purchase transaction comprising transmitting from the merchant to the validation service provider the challenge hardware identification number and the credit card account number; and (d) if the challenge credit card account number is equal to the approved credit card account number and if the challenge hardware identification number is equal to the approved hardware identification number, validating the purchase transaction.

It is to be appreciated that the systems, programs and methods of the present invention are not limited to use only with consumer credit cards, debit cards, or other private data, but may be used to protect business, commercial, governmental, military or any other data requiring a high level of security.

It is therefore an object of the present invention to provide increased security for on-line, point of sale, and other consumer credit card purchases.

It is also an object of the present invention to provide a verification mechanism to prevent unauthorized use of improperly obtained consumer credit card data or other information.

It is a further object of the present invention to provide a registration system for consumer credit cards and other personal information to prevent unauthorized use thereof.

Additional objects of the invention will be apparent from the detailed description and the claims herein.

### BRIEF DESCRIPTIONS OF THE DRAWINGS

FIG. 1 is a flow chart showing the general operation of an exemplary point of sale (POS) system of the present invention.

### DETAILED DESCRIPTION

In order to take advantage of the security provided by embodiments of the present invention, an end user (which may be an individual, a business, a government agency, etc.) must first register the credit card, debit, card, bank account, or other item(s). This is preferably accomplished through a web-based system that allows the user to log in with a unique user name and password, and then register all credit cards, debit cards, etc. The user also provides one or more hardware identification number(s) that are allowed to sue the registered items. The hardware identification number(s) may be a MAC Address, Electronic Serial Number (ESN), a International Mobile Station Equipment Identity (IMEI), a Mobile Equipment Identifier (MEID), a User Identity Module Identifier (UIMID), a Expanded UMID (EUMID) of said mobile device, or other similar identifier. Once the items and hardware identification numbers are entered, unless exceptions are provided, the items may only be used on those computers or mobile devices. In some embodiments, a consumer may purchase or download a software application to a computer or mobile device that will automatically register the hardware identification number (e.g. MAC Address) of that computer or mobile device.

Selling agencies or banks will also subscribe to this service. Additional software will be incorporated into their computers allowing communication with the secure database to allow for verification of information and authentication. This software will provide them with an additional level of security against fraudulent purchases/withdrawals being made from their establishments as well as show their desire to protect the individual end users. This product is not limited to selling businesses, but could be incorporated into any business dealing with the transfer of information/funds as a security protocol to ensure access only through designated machines.

Referring to the exemplary transaction flow chart of FIG. 1, it is seen that when the exemplary credit card purchase transaction is initiated (POS), the credit card information is provided to an embodiment of a secure server of the present invention. The first step is a check to determine if the particular credit card involved in the transaction has been registered or subscribed (on file). If not, no security check is performed through the secure server. However, if the credit card has been registered, then the system checks the hardware identification number(s) (in this example, a MAC address) associated with the particular credit card to determine if the transaction is coming from an authorized device. If the hardware identification number for the device matches one registered with the server, the transaction is approved. If not, then in this example, a further authentication is requested, in this case an authentication code. If this code is provided, the transaction is completed; if not, the transaction is rejected. It is to be appreciated that in other embodiments, the further authentication may be excluded such that the transaction will simply be denied if the hardware identification numbers do not match.

By way of example, and without limiting the claims herein, an exemplary telephone transaction may involve a customer service representative entering credit card information in order to process a transaction. In this case, because the hardware identification number for customer service representative's computer is not the same as any of the consumer's computers, the representative may be given a security prompt such as, “this computer is not authorized to process payment, please enter in High Level Security Clearance Pass Code for secondary authentication.” The consumer may then provide a Security Clearance Pass Code (Randomly Generated or Designated by Consumer) to the representative in order to process the order.

By way of another example, and without limiting the claims herein, if a consumer has credit cards (s)he wants to protect, the consumer may log onto a secured server of the present invention (website) and register MAC Addresses for all devices that (s)he wants activated for use with online orders. The consumer may download and install software (to a PC, Mac, Android, iOS, etc.) which is compatible for all operating systems from the website that adds an extension on to all browsers so that at the time of credit card entry and process, the software scans the device's network identity and sends that information (hardware identification number) securely to the secured server to confirm that the computer being used is registered to the credit card being used.

It is to be appreciated that one of the major concepts behind embodiments of the present invention is prevention of credit card theft and fraud. When a criminal or data thief obtains credit card info fraudulently and attempts to use the victims information on his/her computer, embodiments of the present invention will compare the hardware identification number of the thief's computer to those in the consumers profile to see if they match up. If the information cannot be verified, the purchase will not take place, and a fraudulent transaction may be prevented.

It is to be appreciated that as additional merchant websites incorporate the security systems of the present invention, the merchants may be given a certification to display on the web site. This certification will help the consumer feel at ease and confident that they are dealing with a reputable merchant when entering into transactions with them. Downloadable software for personal computers or mobile devices, as well as commercial software may be incorporated into all legitimate online businesses and their websites for added consumer credit card security.

Embodiments of the present invention may be adapted for use by identity theft services, banks, credit unions, merchants, credit card companies, internet search engines (e.g. Google®), computer manufacturers (e.g. Microsoft) and other existing businesses.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

1-13. (canceled)

14. A method for validating a purchase transaction comprising the steps of:
a) using an electronic device to institute a purchase transaction transferring funds from an issuing bank account to an acquiring bank account, said electronic device having a unique hardware identification number associated therewith, and said issuing account having a unique account identification number;
b) electronically transmitting said hardware identification number to said merchant computer;
c) electronically transmitting said hardware identification number and said account identification number from a merchant computer to a verification computer, said verification computer having a database with a plurality of tables in a memory associated therewith;
d) setting a first verification data to one of the group consisting of (i) a first state if at least one table entry in said database comprises each said hardware identification number and said account identification number, (ii) a second state if at least one table entry in said database comprises said hardware identification number and not said account identification number, and (iii) a third state if at least one table entry in said database comprises said account identification number and not said hardware identification number; and
e) electronically transmitting said first verification data from said verification computer to said merchant computer.

15. The method of claim 14, further comprising the step of, if said merchant computer receives said first verification data in said first state, validating said purchase transaction and transferring funds from said issuing bank account to said acquiring bank account.

16. The method of claim 14, further comprising the step of, if said merchant computer receives said first verification data in said second state, cancelling said purchase transaction and transmitting to said electronic device a message stating that the purchase transaction failed to validate.

17. The method of claim 14, further comprising the step of, if said merchant computer receives said first verification data in said third state, requesting a personal identification code from said electronic device.

18. The method of claim 17, further comprising the step of electronically transmitting said personal identification code from said electronic device to said verification computer.

19. The method of claim 18, wherein said step of transmitting said personal identification code comprises the steps of electronically transmitting said personal identification code from said electronic device to said merchant computer and electronically transmitting said personal identification code from said merchant computer to said verification computer.

20. The method of claim 18, further comprising the step of setting a second verification data to one of the group consisting of (i) a first state if at least one table entry in said database comprises each said personal identification and said account identification number and (ii) a second state if at least one table entry in said database comprises said account identification number and not said personal identification code.

21. The method of claim 20, further comprising the step of, if said merchant computer receives said second verification data in said first state, validating said purchase transaction and transferring funds from said issuing bank account to said acquiring bank account.

22. The method of claim 20, further comprising the step of, if said merchant computer receives said second verification data in said second state, cancelling said purchase transaction and transmitting to said electronic device a message stating that the purchase transaction failed to validate.

23. The method of claim 14, said electronic device comprising a network interface, said hardware identification number comprising a media access control (MAC) address of said network interface.

24. The method of claim 14, said electronic device comprising a mobile device, said hardware identification number comprising one of the group consisting of a Electronic Serial Number (ESN), a International Mobile Station Equipment Identity (IMEI), a Mobile Equipment Identifier (MEID), a User Identity Module Identifier (UIMID), and a Expanded UMID (EUMID) of said mobile device.

25. The method of claim 14, said hardware identification number further comprising one of the group consisting of a Mobile Identification Number (MIN), a Mobile Subscription Identification Number (MSIN), a Mobile Station ID (MSID), a Short IMSI (IMSI_S) of said mobile device.

26. The method of claim 14, said electronic device comprising a processor, said hardware identification number comprising unique serial number of said processor.

27. The method of claim 14, said electronic device comprising a hardware security module associated therewith, said hardware identification number comprising a hardware token of said hardware security module.

28. The method of claim 14, said electronic device comprising a read only memory element associated therewith, said hardware identification number comprising data stored in said read only memory element.

29. The method of claim 28, said read only memory element comprising one of the group consisting of a programmable read only memory (PROM) and a one-time programmable read only memory (OTPROM) element.

30. The method of claim 14, said issuing bank account comprising a credit card account.

31. The method of claim 14, said acquiring bank account comprising a checking account.

32-36. (canceled)
